(19) United States
(12) Patent Application Publication
(10) Pub. No.: US 2011/0164844 A1
(43) Pub. Date: Jul. 7, 2011

(54) OPTICAL MODULATOR

(75) Inventors: Kaoru Higuma, Tokyo (JP); Junichiro Ichikawa, Tokyo (JP)

(73) Assignee: SUMITOMO OSAKA CEMENT CO., LTD., Tokyo (JP)

(21) Appl. No.: 12/998,071

(22) PCT Filed: Sep. 16, 2009
(86) PCT No.: PCT/JP2009/066174

§ 371 Date: Mar. 15, 2011

(30) Foreign Application Priority Data
Sep. 19, 2008 (JP) 2008-241305

(51) Int. Cl. G02F 1/035

(52) U.S. Cl. 385/2

(57) ABSTRACT

It's an object of the invention to provide an optical modulator with high performance. The optical modulator 1 includes a substrate 4 having an electro-optical effect, an optical waveguide 5 formed on the substrate, and control electrodes 61 to 65 for controlling optical waves propagating in the optical waveguide, wherein the optical waveguide 5 includes a main Mach-Zehnder (MZ) type waveguide 50 having two branch waveguides and sub Mach-Zehnder (MZ) type waveguides 51 and 52 disposed in the branch waveguides, respectively, an optical intensity adjusting means (for example, including optical waveguides 53 and 54 and control electrodes 63 and 64) is disposed in each branch waveguide in series with the sub Mach-Zehnder type waveguides 51 and 52, and the optical modulator further comprises a voltage control circuit that monitors some of the optical waves propagating in the branch waveguides and adjusts a voltage applied to the optical intensity adjusting means.

### BACKGROUND OF THE INVENTION

1. Field of the Invention

The present invention relates to an optical modulator, and more particularly, to an optical modulator generating a multilevel phase-modulated signal such as a DQPSK modulator and an FSK modulator.

2. Description of the Related Art

In next-generation long-distance and high-capacity optical communication systems requiring an increase in speed and capacity with the increase in communication traffic, the introduction of a multi-value modulation and demodulation encoding technique has been studied. A representative example is a differential quadrature phase shift keying (DQPSK) technique. In this technique, an increase in sensitivity in addition to a narrow signal band, an improvement in frequency use efficiency, and an increase in transmission distance can be expected, compared with the past two-value intensity modulation (OOK: On-Off Keying) technique.

As described in PTL 1, the DQPSK modulator includes MZ modulators for generating an I (In-phase) signal and a Q (Quadrature) signal, which are integrated in optical paths of two branch waveguides of a Mach-Zehnder (MZ) type interferometer, respectively, and a π/2 phase shifter orthogonalizing the phases of two optical signals.

### CITATION LIST

### Patent Literature

PTL 1: U.S. Pat. No. 7,116,460
PTL 2: JP-A-2006-242975

### Non-Patent Literature

NPL 1: Masataka Nakazawa, Jumpei Hongo, Keisuke Kasai, Masato Yoshida; Res. Inst. of Electrical Communication, Tohoku Univ., Japan. “Polarization-Multiplexed 1 Gsymbol/s, 64 QAM (12 Gbit/s) Coherent Optical Transmission over 150 km with an Optical Bandwidth of 2 GHz”, OFC07 PDP26

In a frequency shift keying (FSK) modulation technique using frequency modulation, as disclosed in PTL 2, a sub Mach-Zehnder (sub MZ) type waveguide is disposed in each of two branch waveguides constituting a main Mach-Zehnder (main MZ) type waveguide, a DC bias and an RF signal are applied to the respective sub MZ type waveguides, and a signal based on modulation data is applied to the main MZ type waveguide.

An SSB (Single Side-Band) modulator using an optical modulator in which sub MZ type waveguides are assembled into branch waveguides of a main MZ type waveguide has also been proposed. As disclosed in NPL 1, a QAM (Quadrature Amplitude Modulation) modulator has also been proposed.

However, in the DQPSK modulator, an intensity difference is generated between an I signal component and a Q signal component due to secondary factors such as a variation in wavelength of optical waves incident on two branch waveguides of the MZ type interferometer, a pattern error in an optical waveguide as an MZ type interferometer, and individual differences in modulation signal by amplifiers, thereby not performing a DQPSK modulation operation with high performance.

In the FSK modulation, when the shapes of the branch waveguides of the main MZ type waveguide are out of balance with each other, an unnecessary frequency component remains in the output optical spectrum, thereby causing the degradation in signal quality.

In, consideration of the above-mentioned problems, PTL 2 discloses a modulation method for improving an extinction ratio by adjusting a bias voltage applied to an electrode of an optical modulator including an optical intensity correcting mechanism disposed in each arm (branch waveguide) of a main MZ type waveguide or sub MZ type waveguides. Particularly, by correcting the imbalance between the arms of the main MZ type waveguide with using the sub MZ type waveguides, it is possible to obtain the optimal bias voltage.

However, in the DQPSK modulator and the FSK modulator, it is not possible to adjust the bias voltage by the method disclosed in PTL 2. That is, in the DQPSK modulator, since the sub MZ type waveguide interferometers are used to apply a data signal, they cannot be used to adjust the balance. In the FSK modulator, since sine waves are applied to the sub MZ type waveguide interferometers to generate two frequency keys, it is difficult to use the sub MZ type waveguides to solve the imbalance, like the DQPSK modulator.

### SUMMARY OF THE INVENTION

A goal of the invention is to solve the above-mentioned problems and to provide an optical modulator with high signal quality that generates a multilevel phase-modulated signal, such as a DQPSK modulator or an FSK modulator. In particular, another goal of the invention is to provide an optical modulator with high performance, which can suppress degradation of the modulation characteristics due to an intensity difference between signal components resulting from optical modulator manufacturing differences and the like and can improve the characteristics without using a complicated manufacturing process.

To accomplish the above-mentioned goals, Aspect 1 of the invention provides an optical modulator including a substrate having an electro-optical effect, an optical waveguide formed on the substrate, and a control electrode for controlling optical waves propagating in the optical waveguide, wherein the optical waveguide includes a main Mach-Zehnder type waveguide having two branch waveguides and sub Mach-Zehnder type waveguides disposed in the branch waveguides, respectively, optical intensity adjusting means is disposed in each branch waveguide to be in series with the sub Mach-Zehnder type waveguides, and the optical modulator further includes a voltage control circuit that monitors some of the optical waves propagating in the branch waveguides and adjusts a voltage to be applied to the optical intensity adjusting means.

Aspect 2 of the invention provides the optical modulator according to Aspect 1, wherein the optical intensity adjusting means is formed of an intensity modulator including a Mach-Zehnder type waveguide.

Aspect 3 of the invention provides the optical modulator according to Aspect 1 or 2, wherein the optical modulator is used as one of an SSB modulator, a DQPSK modulator, an FSK modulator, and a QAM modulator.

According to Aspect 1 of the invention, in the optical modulator including a substrate having an electro-optical effect, an optical waveguide formed on the substrate, and a control electrode for controlling optical waves propagating in the optical waveguide, given that the optical waveguide includes a main Mach-Zehnder type waveguide having two branch waveguides and sub Mach-Zehnder type waveguides disposed in the branch waveguides, respectively, optical intensity adjusting means is disposed in each branch waveguide to be in series with the sub Mach-Zehnder type waveguides, and the optical modulator further includes a voltage control circuit that monitors some of the optical waves propagating in the branch waveguides and adjusts a voltage to be applied to the optical intensity adjusting means, it is possible to provide an optical modulator with high performance which can optimally adjust the intensity of the optical waves propagating in the branch waveguides of the main MZ type waveguide and can suppress the degradation in modulation characteristics due to the intensity difference between the signal components.

Since the optical intensity adjusting means is disposed in each of two branch waveguides of the main MZ type waveguide, it is possible to adjust the optical intensity of the optical waves propagating in any branch waveguide and thus to provide an optical modulator having an excellent modulation characteristic.

Since the optical modulator further includes the voltage control circuit that monitors some of the optical waves propagating in the branch waveguides and adjusts the voltage to be applied to the optical intensity adjusting means, it is possible to adjust the optical intensity appropriately depending on the operating state of the optical modulator, thereby providing an optical modulator with high performance.

According to Aspect 2 of the invention, since the optical intensity adjusting means is formed of an intensity modulator including a Mach-Zehnder type waveguide, the optical intensity adjusting means may be formed in the same process of the optical waveguide or the control electrode which form the optical modulator and may be assembled into the optical modulator in advance.

According to Aspect 3 of the invention, since an optical modulator is used as one of an SSB modulator, a DQPSK modulator, an FSK modulator, and a QAM modulator, it is possible to implement an optical modulator with high performance for the SSB modulator, the DQPSK modulator, the FSK modulator, and the QAM modulator in which the intensity difference of the optical waves propagating in two branch waveguides of the main MZ type waveguide affects the quality of the modulation characteristics of the optical modulator.

### BRIEF DESCRIPTION OF THE DRAWINGS

FIG. 1 is a diagram schematically illustrating the configuration of an optical modulator according to the invention, for example, a DQPSK modulator.

FIG. 2 is a diagram schematically illustrating an example where the optical modulator shown in FIG. 1 is formed of a Z-cut substrate.

FIG. 3 is a diagram schematically illustrating an example where the optical modulator shown in FIG. 1 is formed of an X-cut substrate.

FIG. 4 is a diagram schematically illustrating the configuration of an optical modulator according to the invention, for example, an SSB modulator.

FIG. 5 is a diagram schematically illustrating the configuration of an optical modulator according to the invention, for example, an FSK modulator.

FIG. 6 is a diagram schematically illustrating an example where a voltage control circuit for optical intensity adjusting means is provided to the optical modulator according to the invention.

FIGS. 7A and 7B are diagrams illustrating examples of monitoring means.

### DETAILED DESCRIPTION OF THE INVENTION

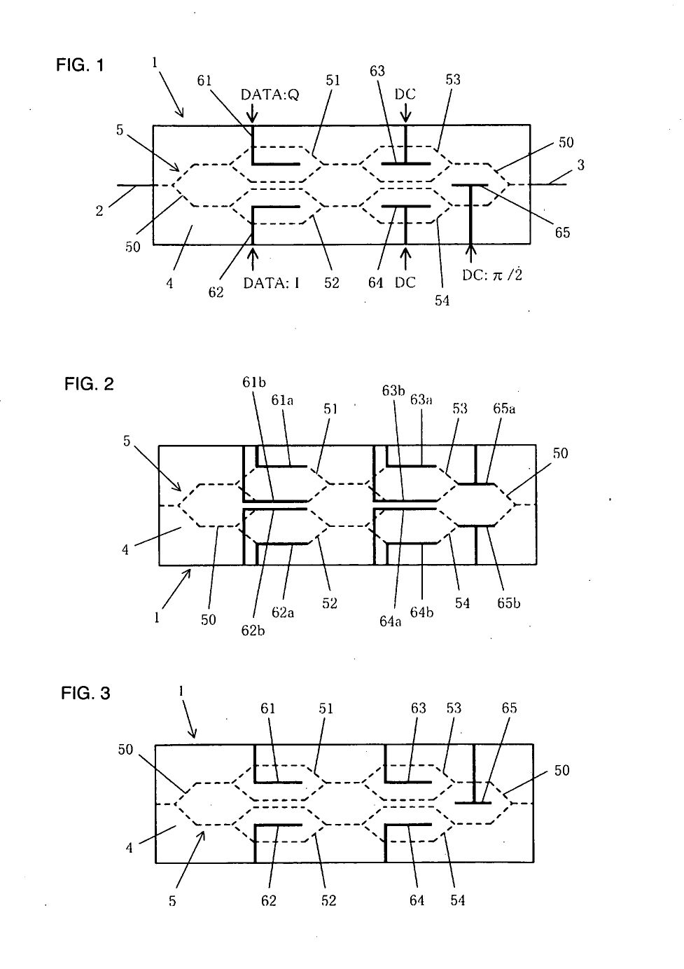

Hereinafter, the invention will be described in detail with reference to examples shown in FIGS. 1 to 5.

The invention provides an optical modulator 1 including a substrate 4 having an electro-optical effect, an optical waveguide 5 formed on the substrate, and control electrodes 61 to 65 for controlling optical waves propagating in the optical waveguide, wherein the optical waveguide 5 includes a main Mach-Zehnder (MZ) type waveguide 50 having two branch waveguides and sub Mach-Zehnder (MZ) type waveguides 51 and 52 disposed in the branch waveguides, respectively, and an optical intensity adjusting means (for example, including optical waveguides 53 and 54 and control electrodes 63 and 64) is disposed in each branch waveguide to be in series with the sub Mach-Zehnder type waveguides 51 and 52.

The substrate 4 having an electro-optical effect can be formed of a material such as lithium niobate, lithium tantalate, PLZT (Lead Lanthanum Zirconate Titanate), and quartz. The optical waveguide 5 can be formed by diffusing titanium (Ti) or the like onto the surface of the substrate using a thermal diffusion method or a proton exchange method. The modulation electrodes 61 to 65 or ground electrodes (not shown) as the control electrodes can be formed through the use of formation of Ti and Au electrode patterns and gold plating. A buffer layer of a dielectric of SiO₂ or the like may be formed on the surface of the substrate on which the optical waveguide has been formed as needed, whereby it is possible to prevent the optical waves propagating in the optical waveguide from being absorbed or scattered by the electrodes formed on the optical waveguide as shown in FIG. 2.

FIG. 1 illustrates an example of a DQPSK modulator. In the optical waveguide 5, the sub MZ type waveguides 51 and 52 are formed in two branch waveguides constituting the main MZ type waveguide 50. In an interferometer formed of the sub MZ type waveguide 51, a modulation signal for generating a Q (Quadrature) signal is applied to the control electrode (where the ground electrode is not shown) 61. In an interferometer formed of the sub MZ type waveguide 52, a modulation signal for generating an I (In-phase) signal is applied to the control electrode 62. A DC bias for shifting the phase by π/2 is applied to the main MZ type waveguide 50 through the control electrode 65.

The optical modulator 1 is connected to an input optical fiber 2 for inputting optical waves and an output optical fiber 3 for outputting optical waves.

The optical waves input to the main MZ type waveguide 50 is divided by and propagates in two branch waveguides. At the time of dividing the optical waves, an intensity difference is caused between the optical waves propagating in the branch waveguides due to the wavelength variation of the optical waves or the imbalance in pattern shape of the optical waveguides. An intensity difference is caused between an optical wave having an I signal component and an optical wave having a Q signal component due to a difference in relative position of the sub MZ type waveguides 51 and 52 and the control electrodes 61 and 62 or the intensity difference between the modulation signals applied to the control electrodes.

In order to adjust the intensity differences, an optical intensity adjusting means is provided to the branch waveguides constituting the main MZ type waveguide in the optical modulator according to the invention.

Various optical attenuators or optical amplifiers can be used as the optical intensity adjusting means. An intensity modulator having the Mach-Zehnder type waveguides 53 and 54 can be preferably constructed as shown in FIG. 1, similarly to the main MZ type waveguide or the sub MZ type waveguides, from the viewpoint of suppressing the number of components, simplifying the manufacturing process, and making adjustment easy. The control electrodes 63 and 64 used in the optical intensity adjusting means can be preferably formed similarly to the control electrodes 61, 62, and 65 used in the DQPSK modulator.

When the optical intensity adjusting means is disposed in both of the two branch waveguides of the main MZ type waveguide, it is possible to more precisely adjust the intensity of the optical waves propagating in the branch waveguides. The optical intensity adjusting means is disposed before or after the sub MZ type waveguide in series therewith.

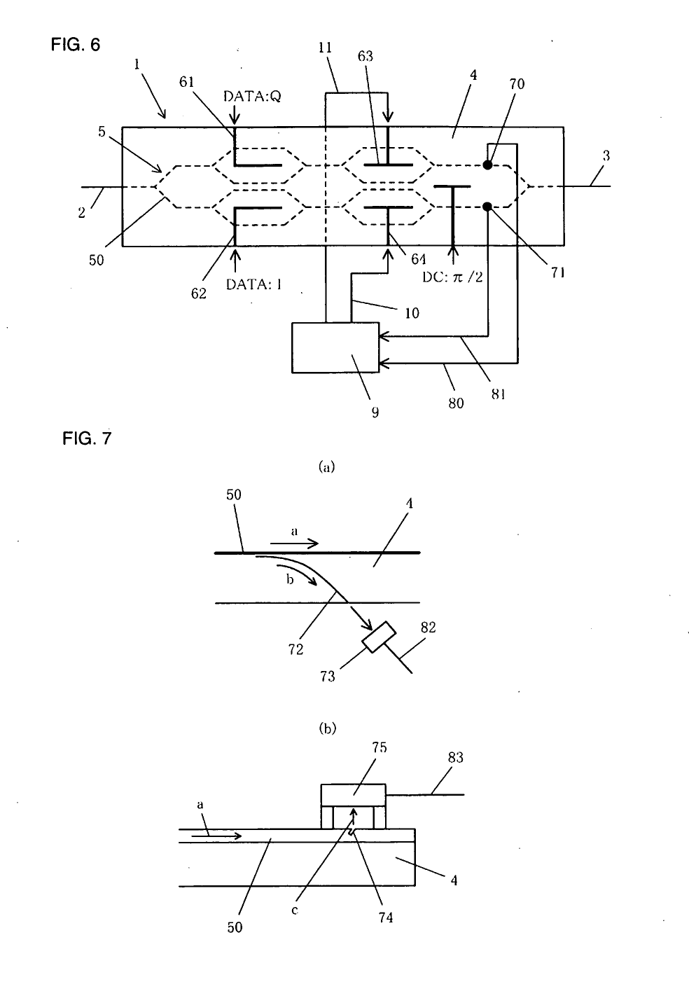

A DC bias is applied to the control electrodes 63 and 64 constituting the optical intensity adjusting means. As shown in FIG. 6, a voltage control circuit 9, that monitors some of the optical waves propagating in the branch waveguides of the main MZ type waveguide and controls the DC bias voltages 10 and 11 so that the extinction ratio or the optical intensity of the monitored optical waves has the optimal value, is disposed in order to set the values of the DC bias voltages to correct values. As the optical waves to be monitored in the invention, radiation-mode light radiated from a wave merging point of the optical intensity adjusting means including the sub MZ type waveguide or the MZ type interferometer in addition to the optical waves propagating in the branch waveguides can be observed. In FIG. 6, reference numerals 70 and 71 represent monitoring means and reference numerals 80 and 81 represent detection signals output from the monitoring means 70 and 71, respectively.

An example of the method of monitoring the output light is a method of forming an auxiliary waveguide 72 adjacent to the branch waveguides of the main MZ type waveguide 50, guiding some of signal light a to the waveguide 71 for detection, and introducing detection light b into a light-receiving element 73 disposed outside the substrate 4, as shown in FIG. 7A. As shown in FIG. 7B, a method of forming an inclined notch 74 in a part of the branch waveguide, reflecting some of the signal light a to the upside of the substrate 4, and detecting reflected light c by the use of a light-receiving element 75 can also be used. When the optical modulator according to the invention includes the main MZ type waveguide and plural MZ type waveguides, various optical waves including the radiation-mode light propagate in the substrate 4. Accordingly, when it is intended to satisfactorily detect an optical wave of interest, it is preferable that some of the optical wave of interest is directly monitored using the auxiliary waveguide or reflecting means shown in FIGS. 7A and 7B or a light refracting film.

An example of the method of controlling the optical intensity adjusting means in the voltage control circuit 9 is a method of setting a modulation state where the optical intensities of the optical waves propagating, in the branch waveguides are the same, such as a state where any of the modulation signals associated with the Q signal and the I signal is not applied to the control electrodes of the sub MZ type waveguides or a state where the same modulation signals are applied to the sub MZ type waveguides, and setting and adjusting DC bias voltages of the optical intensity adjusting means so that the monitored signal outputs are the same. When the state of the modulation signals applied to the sub MZ type waveguides is determined in advance, the optical intensity adjusting means may be adjusted so that the actually monitored optical intensity is equal to the optical intensity of an ideal optical wave when the modulation signals are applied.

The optical intensity adjusting means may be disposed before the sub MZ type waveguide, and optical waves affected by the optical intensity adjusting means but not affected by the modulation resulting from the sub MZ type waveguide, such as the output light of the optical intensity adjusting means or the radiation-mode light, may be monitored. In this case, regardless of the modulation state of the sub MZ type waveguide, it is possible to optimally set the optical intensity of the optical waves propagating in the branch waveguides of the main MZ type waveguide.

FIG. 2 illustrates an example of an optical modulator formed of a Z-cut substrate, where the optical waves propagating in the sub MZ type waveguides are modulated by control electrodes (modulation electrodes) 61a and 61b formed above the branch waveguides constituting the sub MZ type waveguides. The same is true of the sub MZ type waveguide 52, and control electrodes (modulation electrodes) 65a and 65b modulating the optical waves propagating in the main MZ type waveguide are formed above the branch waveguides, similarly.

In FIG. 2, the Mach-Zehnder type waveguides 53 and 54 are used as the optical intensity adjusting means and control electrodes 63a, 63b, 64a, and 64b are disposed in the branch waveguides of the Mach-Zehnder type waveguides.

FIG. 3 illustrates an example of an optical modulator formed of an X-cut substrate, where the control electrodes (modulation electrodes) 61 to 65 are used basically similar to the example shown in FIG. 1.

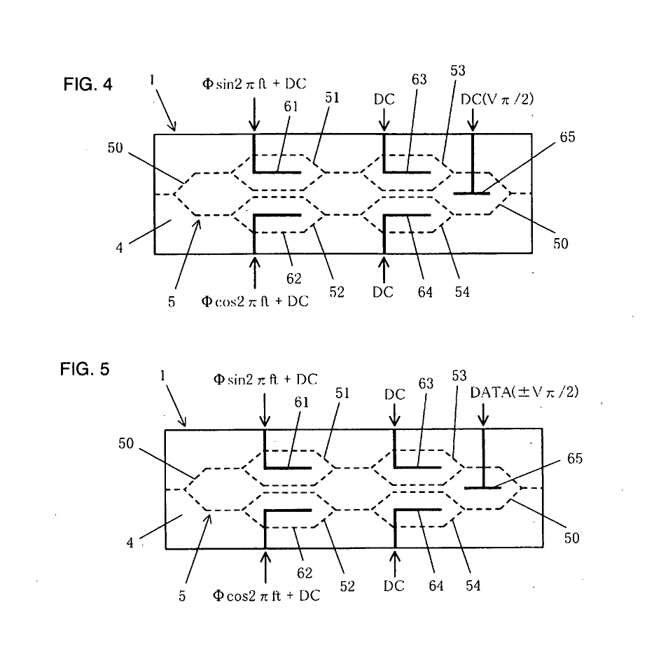

FIG. 4 illustrates an example where the optical modulator is used as an SSB modulator (SSB-SC modulation). Here, a modulation signal “Φ sin 2πft+DC” (where Φ represents the amplitude voltage of the modulation signal, f represents the modulation frequency, and DC represents a predetermined bias voltage) is applied to the interferometer including the sub MZ type waveguide 51, and a modulation signal “Φ cos 2πft+DC” is applied to the interferometer including the sub MZ type waveguide 52.

In the main MZ type waveguide, a DC, bias voltage corresponding to Vπ/2 is applied to the control electrode 65. SSB modulator shown in FIG. 4 is provided with the optical intensity adjusting means including the optical waveguides 53 and 54 and the control electrodes 63 and 64, similarly to the configuration shown in FIG. 1.

FIG. 5 illustrates an example of an FSK modulator, which basically has the same configuration as the SSB modulator shown in FIG. 4, except that the modulation signal applied to the control electrode 65 disposed in the main MZ type waveguide is a modulation data signal of ±Vπ/2.

As described above, the optical modulator according to the invention can be preferably applied to an optical modulator in which the intensity difference between the optical waves propagating in two branch waveguides of a main MZ type waveguide affects the modulation characteristic of the optical modulator. Specifically, it is possible to embody an optical modulator with high performance by applying the invention to an SSB modulator, a DQPSK modulator, an FSK modulator, and a QAM modulator.

According to the above-mentioned invention, it is possible to provide an optical modulator with high signal quality that generates a multilevel phase-modulated signal, such as a DQPSK modulator or an FSK modulator. Particularly, it is possible to provide an optical modulator with high performance, which can suppress the degradation in modulation characteristics due to an intensity difference between signal components resulting from optical modulator manufacturing differences and the like and can improve the characteristics without using a complicated manufacturing process.

### REFERENCE SIGNS LIST

1: OPTICAL MODULATOR
2 and 3: OPTICAL FIBER
4: SUBSTRATE
5: OPTICAL WAVEGUIDE
10 and 11: DC BIAS VOLTAGE
50: MAIN Mach-Zehnder TYPE WAVEGUIDE
51 and 52: SUB Mach-Zehnder TYPE WAVEGUIDE
53 and 54: Mach-Zehnder type WAVEGUIDE
61 to 65: CONTROL ELECTRODe
70 and 71: MONITORING MEANS
72: AUXILIARY WAVEGUIDE
73 and 75: LIGHT-RECEIVING ELEMENT
74: REFLECTING MEANS
80 to 83: DETECTION SIGNAL

1. An optical modulator comprising a substrate having an electro-optical effect, an optical waveguide formed on the substrate, and a control electrode for controlling optical waves propagating in the optical waveguide,
wherein the optical waveguide comprises a main Mach-Zehnder type waveguide having two branch waveguides and sub Mach-Zehnder type waveguides disposed in the branch waveguides, respectively,
wherein an optical intensity adjusting means is disposed in each branch waveguide to be in series with the sub Mach-Zehnder type waveguides, and
wherein the optical modulator further comprises a voltage control circuit that monitors some of the optical waves propagating in the branch waveguides and adjusts a voltage to be applied to the optical intensity adjusting means.

2. The optical modulator according to claim 1, wherein the optical intensity adjusting means is formed of an intensity modulator comprising a Mach-Zehnder type waveguide.

3. The optical modulator according to claim 1, wherein the optical modulator is used as one of an SSB modulator, a DQPSK modulator, an FSK modulator, and a QAM modulator.

4. The optical modulator according to claim 2, wherein the optical modulator is used as one of an SSB modulator, a DQPSK modulator, an FSK modulator, and a QAM modulator.
